(19) United States
(12) Patent Application Publication
(10) Pub. No.: US 2018/0062879 A1
(43) Pub. Date: Mar. 1, 2018

(54) SYSTEMS AND METHODS FOR INCREASING NETWORK ACCESS CAPACITY

(71) Applicant: Roger Kirk ALEXANDER, Rockville, MD (US)

(72) Inventor: Roger Kirk ALEXANDER, Rockville, MD (US)

(73) Assignee: COOPER TECHNOLOGIES COMPANY, Houston, TX (US)

(21) Appl. No.: 15/252,690

(22) Filed: Aug. 31, 2016

(51) Int. Cl. H04L 12/66; H04W 40/32; H04L 12/741; H04L 12/751; H04L 12/733; H04L 12/721

(52) U.S. Cl. CPC H04L 12/66; H04W 40/32; H04L 45/745; H04W 84/18; H04L 45/122; H04L 45/26; H04L 45/02

(57) ABSTRACT

A communications system capable of being used to add capacity to a wireless mesh network is described herein. In one exemplary embodiment, a communications system includes a primary gateway device having a first identifier, and a first plurality of communications devices assigned the first identifier. The primary gateway device provides network access to a communications server and describes a first segment of the communications system including the first plurality. The communications system also includes at least one auxiliary gateway device having a second identifier and an auxiliary gateway designation that allows hierarchical independence of the first segment. A second plurality of communications devices can be included that are assigned the first identifier but also able to establish communications association with the auxiliary gateway device to use the second identifier such that, when the second plurality seek to communicate with a communications server, the auxiliary gateway device is structured to facilitate the communications.

### BACKGROUND

### Field

The disclosed concept relates generally to systems and methods for increasing fixed network access capacity, such as increasing network access capacity available within a wireless mesh network by adding auxiliary gateway devices within a network supporting automatically segmenting and merging routing domains.

### Background Information

The use of wireless communications devices is increasing almost daily. As such, the capacity of large networks of wireless communications device is also needed to increase to accommodate a network's increased load. Routing scalability, for instance, is a unique feature of some ad-hoc mesh networks. This allows for the network to automatically segment and merge routing domains so that a large network of wireless communications devices are not operating within the confines of a single routing domain. Each wireless communications device structures so that it can automatically self-segment into a particular segment of the network associated with a localized network gateway device. The wireless communications devices within each particular segment therefore only need to store routing information specific to the particular segment within which it has been self-segmented, along with gateway device routing information associated with the gateway devices within the network.

By maintaining the routing information associated with a particular wireless communication device's network segment, along with gateway device routing information, each wireless communications device has less information which must be maintained locally, thereby providing unique scalability for the network. Furthermore, as each device maintains routing information to each gateway device within the network, each device is still capable of accessing one or more separate wireless communications devices and/or gateway devices that are not associated with their own network segment. Techniques for automatically segmenting wireless communications devices within a network is described in more detail within commonly-assigned U.S. Pat. No. 8,295,295, which is issued on Oct. 23, 2012, which is incorporated herein by reference in its entirety.

Each communications device is also structured to employ various standardized routing protocols. For instance, routing protocols associated with maintaining dynamic and reconfigurable routing metric information may be used by the communications devices. Such routing protocols are described in greater detail within commonly assigned U.S. Pat. No. 7,035,207, which issued on Apr. 25, 2006, the disclosure of which is incorporated herein by reference in its entirety. Furthermore, various other standardized Internet Protocol (“IP”) based routing techniques are capable of being used with the automatic segmentation and merge routing domain procedures.

The gateway device acts as a network access interface for the wireless communications devices of the network and one or more additional networks, including fixed server networks, using wide area network (“WAN”) connectivity. The gateway devices typically include a radio device that allows the gateway device to form part of, as well as participate in, the wireless network of communications devices. A radio or non-radio (fixed network) device also allows the gateway device to form part of and participate in a WAN. As an illustration, types of WAN include, but are not limited to, Public Switched Telephone Networks (“PSTN”), the Internet, and/or cellular communications networks.

The ability of a communications device to automatically and dynamically form routing domains, or segments, within a network is powerful, however it may also be democratic according to uniform rules applicable to all devices within the routing domain. When a new gateway device is added to the network, or if an existing gateway device fails, the communications devices within that failed gateway device's segment autonomously redistribute and form segments around other gateway devices. For instance, if a new primary gateway device is added to a network to provide additional capacity for network access, all of the communications devices self-segment and redistribute themselves amongst all of the available gateway devices. This means that fewer communications devices will likely be associated with each of the gateway devices. Similarly, if one of the gateway devices fails (e.g., is no longer capable of providing network connectivity), the communications devices autonomously redistribute about the remaining gateway devices. This means that more communications devices will likely be associated with each of the remaining gateway devices. However, this democratic and self-segmentation limits the ability to provide increased capacity to a select few communications devices, without impacting the dynamic segmentation feature of the network around the available gateway devices.

There is, therefore, room for improvement in such networks to provide both the routing scalability and operational reliability of automatic segmentation and targeted gateway capacity that can be added for selected or designated communications devices or communications without impacting automatic segmentation.

### SUMMARY

These needs and others are met by embodiments of the disclosed concept, which are directed to increasing the capacity of a multi-hop mesh network such that automatic segmentation and targeted auxiliary gateway capacity is capable of being used.

As one aspect of the disclosed concept, a communications system is provided. The communications system includes a first primary gateway device for facilitating communications of a first data type, the first primary gateway device having a first color identifier associated with a first network segment of a multi-hop mesh network, and the first primary gateway device having a first fixed connection to a communications server. The communications system further includes at least one first communications device capable of communicating communications of the first data type with the communications server via the first primary gateway device, the at least one first communications device having the first color identifier indicating that the at least one first communications device is part of the first network segment. The communications system yet further includes a first auxiliary gateway device for facilitating communications of a second data type, the first auxiliary gateway device having a second color identifier, the second color identifier indicating that the first auxiliary gateway device is independent of the first network segment, and the first auxiliary gateway device having a second fixed connection to the communications server. The communications system further still includes at least one second communications device capable of communicating with the communications server via the first auxiliary gateway device. The at least one second communications device having the first color identifier indicating that the at least one second communications device is part of the first network segment, and able to use the second color identifier indicating that the at least one second communications device communicates data of the second data type with the first auxiliary gateway device.

As another aspect of the disclosed concept, a system is provided. The system includes a first network device, a first plurality of communications devices, a second network access device, and a second plurality of communications devices. The first network access device is capable of communicating with a server, and has a first identifier corresponding to a first segment of a network. The first plurality of communications devices are in communication with the first network access device and have the first identifier. The second network access device is capable of communicating with the server via the second network device and has a second identifier. The second plurality of communications devices has the first identifier and uses the second identifier for communicating with the server via the second network device.

As yet another aspect of the disclosed concept, a system is provided. The system includes a first primary network access device having a first identifier. The system also includes a first plurality of communications devices having the first identifier and forming a first network segment. The system further includes a first auxiliary network access device having a second identifier. At least one communications device of the first plurality of communications devices is structured to communicate with the first auxiliary network access device and uses the second identifier indicating that the first auxiliary network access device is independent of at least the first primary network device.

### BRIEF DESCRIPTION OF THE DRAWINGS

A full understanding of the disclosed concept can be gained from the following description of the preferred embodiments when read in conjunction with the accompanying drawings in which:

FIG. 1 is an illustrative schematic diagram of a system for automatically segmenting and merging routing domains within a network, in accordance with an embodiment of the disclosed concept;

FIGS. 2A and 2B are illustrative schematic diagrams of a multi-hop network segment including a primary gateway device, in accordance with an embodiment of the disclosed concept;

FIG. 3 is an illustrative schematic diagram of network segmentation including a first primary gateway device having a first color identifier and a second primary gateway device having a second color identifier, in accordance with an embodiment of the disclosed concept;

FIG. 4 is an illustrative diagram of a network segment including a primary gateway device and an auxiliary gateway device defined within the segment of the primary gateway device, in accordance with an embodiment of the disclosed concept;

FIG. 5 is an illustrative schematic diagram of an exemplary routing table for a communications device within a network, in accordance with an embodiment of the disclosed concept;

FIGS. 6A and 6B are illustrative diagrams of two network segments, each including a primary gateway device, and two auxiliary gateway devices deployed for one or more communications devices of the two network segments, in accordance with an embodiment of the disclosed concept; and

FIG. 7 is an illustrative block diagram of an exemplary communications device, in accordance with an embodiment of the disclosed concept.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

As employed herein, the term “number” shall mean one or an integer greater than one (i.e., a plurality).

As employed herein, the statement that two or more parts are “electrically coupled” or are in “electrical communication” shall mean that two or more the parts or components are joined together either directly or joined through one or more intermediate parts such that electricity, current, voltage, and/or energy is operable to flow from one part or component to the other part or component, and vice versa.

As employed herein, the term “processor” shall mean a programmable analog and/or digital device that can store, retrieve, and process data; a computer, a workstation; a personal computer; a microprocessor; a microcontroller; a microcomputer; a central processing unit; a mainframe computer; a mini-computer; a server; a networked processor; or any suitable processing device or apparatus.

As employed herein, the term “dynamic range” shall mean the ratio or difference between the smallest and largest possible values of a changeable quantity (e.g., without limitation, amplitude; magnitude).

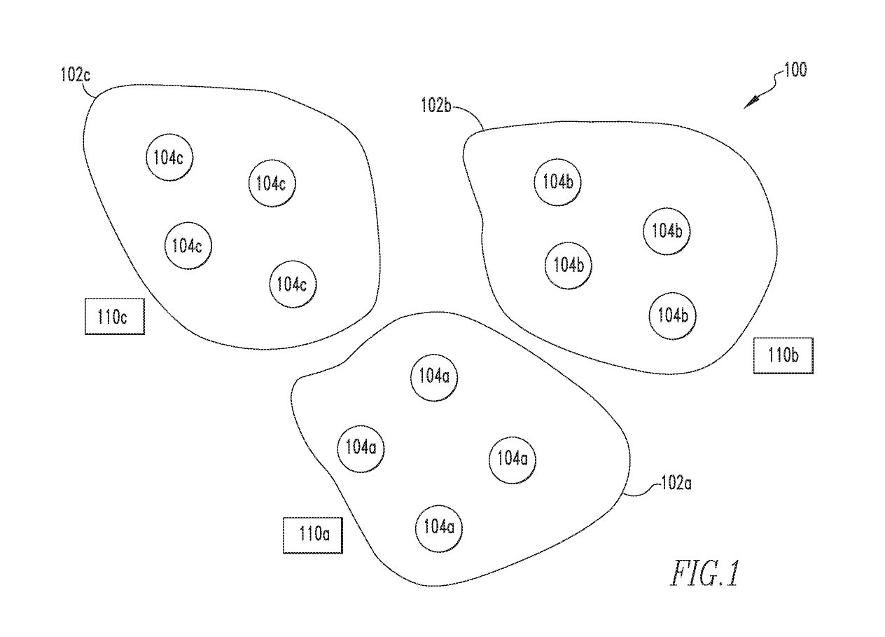

FIG. 1 is an illustrative schematic diagram of a system for automatically segmenting and merging routing domains within a network 100, in accordance with an embodiment of the disclosed concept. Network 100, in the illustrative non-limiting embodiment, includes one or more communications devices 104a, 104b, and 104c, sometimes referred to as “nodes” or “node devices,” and one or more gateway devices 110a, 110b, and 110c, sometimes referred to as “gateways.” Each of gateway devices 110a, 110b, and 110c include, in one embodiment, communications circuitry, such as a radio device, that enable gateway devices 110a, 110b, and/or 110c to communicate with one or more of communications devices 104a, 104b, and 104c. Gateway devices 110a, 110b, and 110c further include a network interface device that enable gateway devices 110a, 110b, and/or 110c to communicate over a Wide Area Network (“WAN”) to a central server device or computing device. Communications devices 104a, 104b, and 104c, in one embodiment, include one or more sensors or actuators, as well as communications circuitry enabling communications devices 104a, 104b, and/or 104c to communicate with one another as well as gateway devices 110a, 110b, and/or 110c.

In one embodiment, gateway devices 110a, 110b, and 110c are provided with an identifier stored thereon. For instance, gateway devices 110a, 110b, and 110c may include communications circuitry, one or more processors, and memory (e.g., volatile and/or non-volatile memory) with which the identifier may be stored. Generally, each identifier is unique to a particular gateway device, however persons of ordinary skill in the art will recognize that this is merely exemplary. By having an identifier that is unique, however, network 100 is capable of automatically segmenting into various segments, such as segments 102a, 102b, and 102c.

Each identifier is capable of being assigned to a particular gateway device upon deployment into network 100, however in an embodiment the identifier is assigned during manufacture. Further still, the identifier is capable of being selected by a particular gateway device, such as, for example, by a gateway device selecting a random value (e.g., string of one or more numbers, letters, and/or characters) to be used as the gateway device's identifier upon activation. While it is possible, in this particular scenario, for two or more gateway devices to select, or be assigned, a substantially similar identifier, manual or automated techniques are capable of being used to intervene to change the identifier to be unique, as described in greater detail within commonly assigned U.S. Pat. No. 8,295,295, which issued on Oct. 23, 2012, and the disclosure of which is incorporated herein by reference in its entirety.

In one embodiment, each gateway device 110a, 110b, and 110c is assigned an identifier, which may be referred to as a “color” identifier, that has a unique value for that particular gateway within network 100. The term “color,” as used herein, is merely illustratively, and is used colloquially to describe a technique for automatically segmenting and merging routing domains within networks, and is not to be interpreted in a literal manner. Each identifier is a value distinct to that gateway device. In the illustrative embodiment, network 100 includes three gateway devices 110a, 110b, and 110c, and the “color” identifiers associated with these gateway devices are “a,” “b,” and “c.”

In one embodiment, each of communications devices 104a, 104b, and 104c are configured to periodically exchange network routing information with other communications devices within their vicinity. By exchanging routing information, each of communications devices 104a, 104b, and 104c are able to learn path to other destination communication devices within network 100 that they are not able to directly communicate with. Each of communications devices 104a, 104b, and 104c builds a routing table, stored within the communication device's memory, of the various paths to use to reach each destination within network 100. The routing information, in one embodiment, also includes information related to the quality of the wireless communication links as well as a number of intermediate hops needed to reach a particular destination such that a communications device is able to select an optimal or best (least-cost) path from a variety of different paths to a particular destination. This path cost metric may be defined on the basis of different communications link or device capability-specific criteria.

Such techniques, as described above, allow each communications devices 104a, 104b, and 104c to adaptively and dynamically learn of the existence and paths to one or more of gateway devices 110a, 110b, and 110c of network 100. From gateway devices 110a, 110b, and 110b, each of communications devices 104a, 104b, and 104c is able to select a single gateway device to use as its primary gateway device. The decision of which gateway device to use as a primary gateway device is based on the path cost that is dependent on one or more factors including, but not limited to, a number of hops to each of gateway devices 110a, 110b, and 110c, a best overall link quality over the entire path to each of gateway devices 110a, 110b, and 110c (e.g., wireless link quality information), the capabilities of communications devices along the path, and/or traffic factors.

In one embodiment, upon determining which gateway device to use as a primary gateway device, each of communications devices 104a, 104b, and 104c assigns itself the color identifier of the selected gateway device. Therefore, the color identifier of each communications device is the same as the color identifier of the selected gateway device. For example, communications devices 104a have a first color identifier (e.g., signified by the letter “a”) associated with gateway device 110a, communications devices 104b have a second color identifier (e.g., signified by the letter “b”) associated with gateway device 110b, and communications devices 104c have a third color identifier (e.g., signified by the letter “c”) associated with gateway device 110c.

As an illustrative example, communications devices 104a have selected gateway device 110a as their primary gateway device, and therefore communications devices 104a communicate with one another and exchange routing information to learn about destinations not directly reachable by themselves, eventually building a routing table of all such destinations and the paths to reach these destinations. The color identifier, therefore, determines which destination to add to the routing table, and which destinations to not add to the routing table. For instance, communications devices 104a will not add routing information associated with communications devices 104b because communications devices 104b are of a different color identifier. Therefore, each communications device stored a routing table including routing information associated with each communications device having the same color identifier. In one embodiment, each communications device further stores, within their routing table, routing information associated with each gateway device 110a, 110b, and 110c within network 110.

Using the various color identifiers, network 100 is grouped into segments 102a, 102b, and 102c, each associated with a unique color identifier. For example, communications devices 104a, having gateway device 110a as their primary gateway device, are associated with a first segment 102a, communications devices 104b, having gateway device 110b as their primary gateway device, are associated with a first segment 102b, and communications devices 104c, having gateway device 110c as their primary gateway device, are associated with a first segment 102c. Persons of ordinary skill in the art will recognize that although only three segments 102a, 102b, and 102c, associated with three gateway devices 110a, 110b, and 110c, are shown within network 100, this is merely exemplary, and any suitable number of gateway devices, and therefore segments, may be employed within network 100.

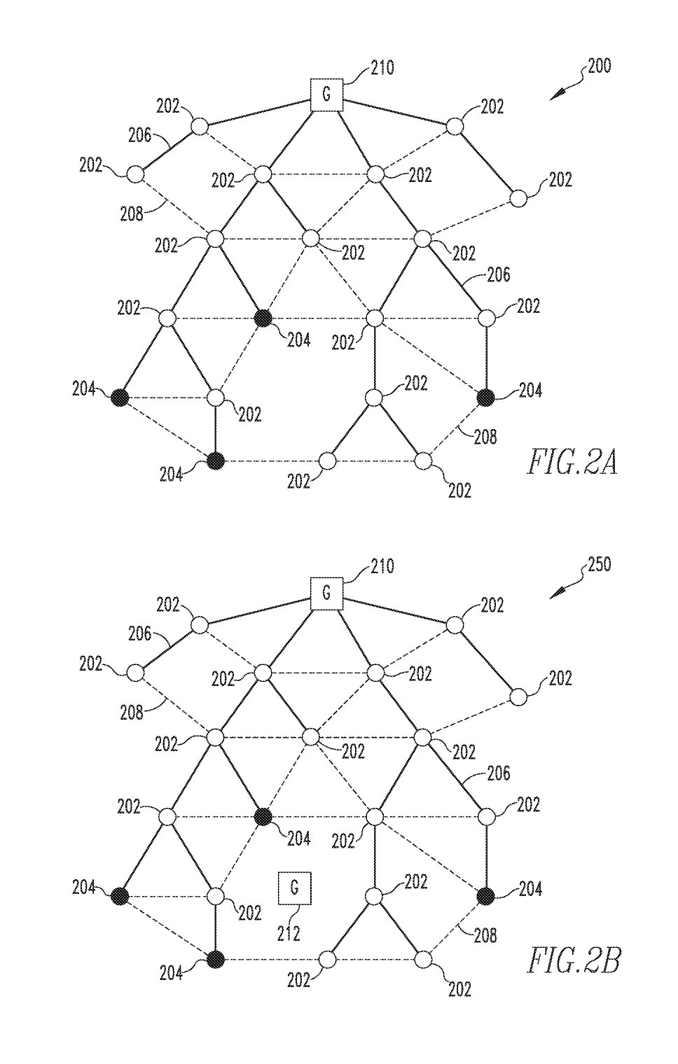

FIGS. 2A and 2B are illustrative schematic diagrams of a network segment 200 including a primary gateway device 210 and a network segment 250 including primary gateway device 210 and an additional primary gateway device 212 added in, in accordance with an embodiment of the disclosed concept. In the illustrative, non-limiting embodiment of FIG. 2A, network segment 200 is described, which corresponds to one segment of a network, such as network 100 of FIG. 1. Network segment 200 includes, in one embodiment, primary gateway device 210, and one or more communications devices 202. Furthermore, in the illustrative embodiment, network segment 200 also includes one or more communications devices 204. Communications devices 202 and 204 each have an identifier (e.g., a color identifier) associated with gateway device 210, which is their primary gateway device, as described in greater detail above. Furthermore, each of communications devices 202 and 204 store routing information to reach the other communications devices 202 and 204 within network segment 200, as well as routing information associated with gateway device 210, and any other gateway device included within the network (e.g., network 100) that may be reachable through the interconnection of network devices.

In one embodiment, communications devices 202 and 204 are substantially similar such that they are both capable of communicating similar data with gateway device 210 (e.g., sending and/or receiving similar data from gateway device 210). However, in a non-limiting embodiment, communications devices 202 are configured to communicate low volume data communications (e.g., sensor data, voltage measurements, energy consumption information, and the like with long, infrequent reporting intervals) with gateway device 210, while communications devices 204 are configured to communicate high volume data communications (e.g., sensor data, voltage measurements, energy consumption information, and the like with short, frequent reporting intervals) with gateway device 210. Other than data volume, communications devices 202 and 204 may be differentiated in on the basis of support for communications related to particular application service types.

Each of communications devices 202 and 204 store routing information indicating an optimal path to gateway device 210. For instance, solid lines 206 correspond to an optimal path from a particular communications device to reach gateway device 210. In one embodiment, the optimal path for a communications device 202, 204 to reach gateway device 210 includes one or more intermediate, or relay, communications devices 202 and/or 204 such that a particular communications device 202 and/or 204 accesses (e.g., sometimes referred to as “hops”) a different communications device 202 and/or 204 in order to reach gateway device 210.

Dashed lines 208, in the illustrative embodiment, correspond to alternative paths that communications devices 202 and/or 204 may take to reach gateway device 210.

These alternative paths typically describe a next hop for a particular communications device within network segment 200. If a next hop for a communications device 202 or 204 is incapable of providing access to gateway device 210, then communications device 202, 204 will attempt to access an adjacent communications device 202, 204, as seen by dashed lines 208, in order to try and reach gateway device 210. A more detailed description of frequency hopping within an ad-hoc mesh network is described in commonly-assigned U.S. Patent Application Publication No. 2016/0165557, corresponding to U.S. patent application Ser. No. 14/867,812, which was filed on Sep. 28, 2015, the disclosure of which is incorporated herein by reference in its entirety.

In an illustrative embodiment of FIG. 2B, communications devices 204 of a network segment 250 of a network (e.g., network 100) correspond to high data volume communications devices. These communications devices may absorb a large quantity of bandwidth for primary gateway device 210. Therefore, to reduce the strain on gateway device 210, and remove any bottle neck of data traffic which may result, a second gateway device, gateway device 212, is added, as seen within segment 250. In the non-limiting, illustrative embodiment, second gateway device 212 has been added at a location radially proximate to communications devices 204. Upon adding second gateway device 212, communications devices 202 and 204 of network segment 250 will dynamically and automatically reconfigure themselves to account for second gateway device 212. FIG. 3 is an illustrative schematic diagram of a network segment 300 including a first primary gateway device 310 having a first color identifier and a second primary gateway device 312 having a second color identifier, in accordance with an embodiment of the disclosed concept. Network segment 300, in one example embodiment, is substantially similar to network segment 250, with the exception that network segment 300 has reorganized and redistributed communications pathways to account for first gateway device 310 and second gateway device 312. In one embodiment, second gateway device 312 has a different color identifier than that of first gateway device 310. Therefore, after being added into the network (e.g., network 100), the communications devices of the network all redistribute themselves based on which gateway device (e.g., gateway device 310 and 312) provides the optimal path to a central server or computing device.

In the example embodiment, communications devices 302 redistribute themselves such that they form a new segment associated with first gateway device 310. Each of communications devices 302, therefore, stores routing information indicating the color identifier it assigns itself, which is associated with gateway device 310, and the additional gateway devices (e.g., gateway device 312, and the like) associated with the network. The routing information, for instance, indicates an optimal path to be used to reach gateway device 310, illustrated solid lines 306. For example, solid lines 306 are substantially similar to solid lines 206 of FIGS. 2A and 2B, indicating an optimal path to gateway device 310, and the previous description may apply. Similarly, dashed lines 308 indicate an alternative path that communications devices 302 are able to take to reach gateway device 310. Dashed lines 308, for example, are substantially similar to dashed lines 208 of FIGS. 2A and 2B, and the previous description may apply.

In the illustrative embodiment, communications devices 304 and 314 also redistribute themselves within network segment 300 such that they now are assigned a second color identifier associated with second gateway device 312. Solid lines 316, therefore, indicate an optimal path to reach gateway device 312, and dashed lines 318 indicate an alternative path.

As mentioned previously, some communications devices correspond to high data volume communications devices. Gateway device 312 had been deployed within network segment 300 (previously within segment 250 of FIG. 2B) to reduce the load of gateway device 310. However, an unintended consequence of the deployment of gateway device 312 is that, because of the democratic nature of communications devices within an automatically self-segmenting multi-hop mesh network, both high data volume communications devices, such as communications devices 304, and non-high data volume communications devices, such as communications devices 314, self-segmented into using gateway device 312. While this still may reduce the traffic to gateway device 310, thereby reducing the load, communications devices 304 may, therefore, still absorb a large amount of traffic to gateway device 312. To reduce the democratic effect of the multi-hop mesh network segmentation, an auxiliary gateway device is deployed within the network segment (e.g., network segment 300) instead of deploying a primary gateway device, as described below.

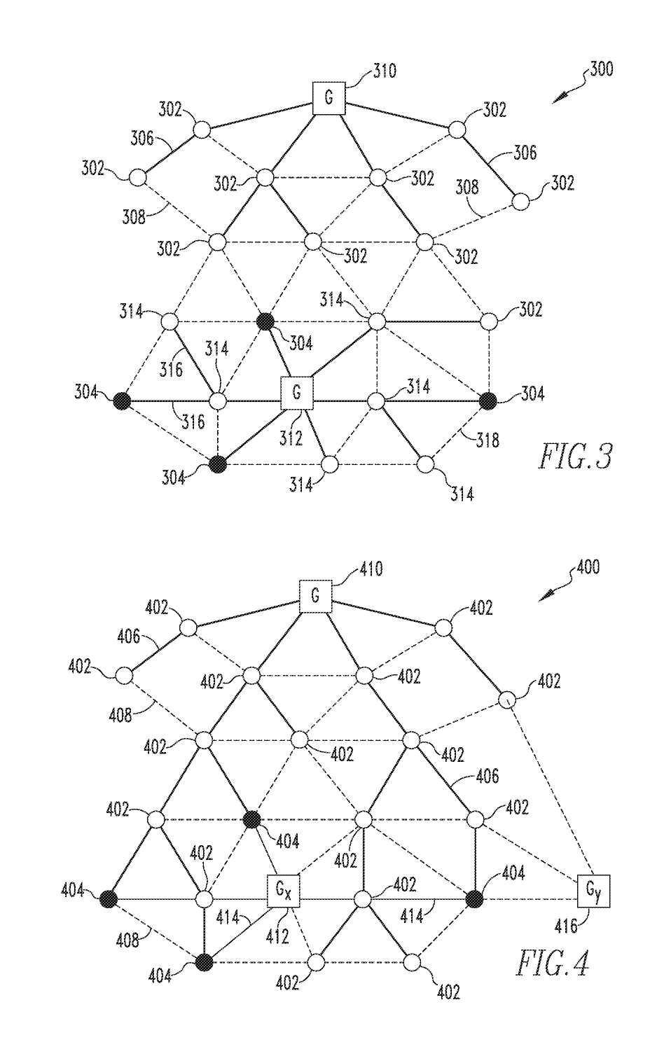

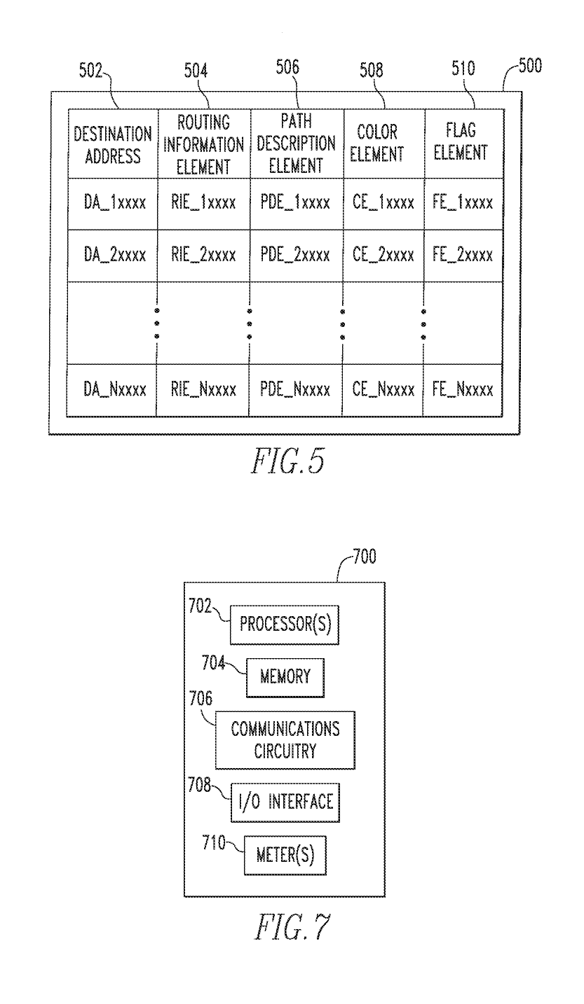

FIG. 4 is an illustrative diagram of a network segment 400 including a primary gateway device 410 and an auxiliary gateway device 412, in accordance with an embodiment of the disclosed concept. In the non-limiting embodiment, network segment 400 of a multi-hop mesh network (e.g., network 100), includes communications devices 402 and communications devices 404. In the illustrative embodiment, communications devices 402 and 404 are substantially similar to communications devices 202 and 204 of FIGS. 2A and 2B, for example, and the previous description may apply. Communications devices 404, for instance, may correspond to high data volume communications devices, which may send/receive high data volume communications to/from a server device. To reduce bandwidth consumption for primary gateway device 410 within network segment 400, one or more auxiliary gateway devices, such as auxiliary gateway device 412 and/or 416, are deployed within network segment 400. In one embodiment, auxiliary gateway device 412 (as well as auxiliary gateway device 416) is provided within a radially proximate region to that of high data communications devices 404, however this is merely exemplary.

In one embodiment, auxiliary gateway device 412 is a gateway device, similar to that of gateway device 410. The auxiliary gateway devices provide a second hierarchical level to that of the primary gateways devices (e.g., primary gateway device 410) within a network segment, and therefore do not affect the segment organization of communications devices that define their routing domain associations only around primary gateway device. Auxiliary gateway device 412, in the illustrative embodiment, is deployed within physical proximity of communications devices 404 of a portion of network segment 400. Gateway device 410, for instance, can be considered to exist at a logical hierarchical level that is ‘above’ that of the primary gateway segment. Primary gateway device 410, as described previously, has a color identifier associated with it. Referring back to FIG. 1, gateway devices 110a, 110b, and 110c were each associated with a different color identifier (labeled by letters “a,” “b,” and “c”), which thereby defined network segments 102a, 102b, and 102c, respectively, of network 100. Primary gateway device 410, in the illustrative embodiment, is associated with one particular color identifier, and auxiliary gateway device 412 is associated with another distinct color identifier. In this way, auxiliary gateway device 412 does not form part of network segment 400 but can be potentially accessible to communications devices that are part of one or more primary network segments.

As with the primary gateway device, the color identifier of an auxiliary gateway device is capable of being assigned to a particular gateway device upon deployment into the network. However, in an embodiment, the identifier is also capable of being assigned during manufacture. Further still, similar to the primary gateway device, the identifier is capable of being selected by a particular auxiliary gateway device, such as, for example, by an auxiliary gateway device selecting a random value (e.g., string of one or more numbers, letters, and/or characters) to be used as the auxiliary gateway device's color identifier upon activation. While it is possible, in this particular scenario, for two or more auxiliary gateway devices to select, or be assigned, a substantially similar identifier, manual or automated techniques are capable of being used to intervene to change the identifier to be unique, as described in greater detail within commonly assigned U.S. Pat. No. 8,295,295, which is issued on Oct. 23, 2012, and the disclosure of which is incorporated herein by reference in its entirety.

In an embodiment, an auxiliary gateway device is capable of being configured for deployment in conjunction with the operation of a particular primary network segment (color). Where such an auxiliary gateway device is configured for such a deployment, and is unable to establish connectivity with communications devices of that particular network segment color, signaling mechanisms may be provided for identifying the network segment color identity of currently connectible communications devices and communicating that information to the communications network server.

The service capability level indicator flag of an auxiliary gateway is capable of being assigned to the auxiliary gateway device during manufacture, however in an embodiment the service capability indicator is also capable of being assigned upon deployment into the network through signaling interaction with the primary gateway device to which the auxiliary gateway deployment is configured. It will be possible for multiple auxiliary gateway devices to be assigned the same service capability level through the manual configuration or automated techniques.

Although the aforementioned description is related to only one auxiliary gateway device (e.g., auxiliary gateway device 412) within the radio environment of network segment 400, persons of ordinary skill in the art will recognize that any number of auxiliary gateway devices may also be included within a particular geographic area. For example, a region of network segment 400 may include a primary gateway device (e.g., gateway device 410), a first auxiliary gateway device (e.g., auxiliary gateway device 412, and a second auxiliary gateway device 416, and/or even more auxiliary gateway devices (e.g., two or more auxiliary gateway devices). In this particular scenario, primary gateway device 410 has a first color identifier assigned to it, first auxiliary gateway device 412 has a second color identifier assigned to it, and second auxiliary gateway device 416 has a third color identifier assigned to it. The respective color identifiers together with the device address identifiers indicate that first auxiliary gateway device 412 and second auxiliary gateway device 416 are unique, and may be accessible to different, potentially disjoint portions of network segment 400. As such, one or more communications devices are capable of being associated to first auxiliary gateway device 412 and one or more communications devices are also capable of being associated to second auxiliary gateway device 416. These communications devices, however, will each have a first color identifier associated with primary gateway device 410.

Upon deployment into a network, and in particular into a region of a network segment, auxiliary gateway devices cause each communications device (e.g., communications devices 402, 404) to update their routing information to include the auxiliary gateway devices (e.g., auxiliary gateway devices 412, 416). Similar to the manner in which deployment of a new primary gateway device into a network causes each communications device to redistribute and update its routing table to include routing information for that new gateway device, inclusion of a new auxiliary gateway device further causes the communications devices to also update their routing table to include routing information for any new auxiliary gateway devices now included within connectivity vicinity of any communications devices of the network that can be interconnected to that network segment. Routing tables may however only maintain routing information for primary or auxiliary gateway devices that are within a defined maximum distance (path cost) horizon. However, unlike the introduction of a primary gateway device, communications devices do not change their primary segment association (e.g., the network segment associated with a particular primary gateway device) on the basis of an auxiliary gateway device's deployment. By updating and maintaining routing information applicable only to gateway devices (auxiliary and primary) that are within a configured maximum horizon limit (which may be measured in path cost or hops, for example), scalability across all of communications devices of a network is able to be maintained even when network access capacity is expanded by the addition of one or more auxiliary gateway devices.

In an illustrative embodiment, auxiliary gateway device 412 is deployed radially proximate to communications devices 404 (e.g., high data volume communications devices). Each of communications devices 402 and 404 then determine whether it is more efficient to communicate with primary gateway device 410 relative to any other primary gateways that may be available. All communications devices 402 and 404 will associate to the primary gateway device (e.g., primary gateway device 410), perform certain network maintenance communications with that primary gateway (e.g., primary gateway device 410), and assign themselves the color identifier associated with that primary gateway device (e.g., primary gateway device 410). However, auxiliary gateway device 412, for example, may be structured such that it facilitates a particular data type, such as, and without limitation, high data volume communications. Therefore, in this particular scenario, only communications devices that are also structured to communicate the particular communications type associated with auxiliary gateway device 412 (e.g., communications devices 404) will be capable of being associated with auxiliary gateway device 412. As such, in addition to the network maintenance functions performed with primary gateway 410, communications devices 404 will perform similar network maintenance communications with auxiliary gateway 412. For example, auxiliary gateway device 412 may be for high data volume communications, and similarly, communications devices 404 may also be for high data volume communications. Therefore, communications devices 404 will be associated with both primary gateway device 410 and auxiliary gateway device 412. Even if one or more communications devices 402 are also located proximate to auxiliary gateway device 412, they will still not associate to the auxiliary gateway device 412 because they are not structured for that particular data type. In this particular exemplary embodiment, communications devices 402 do not support communications of the type associated with auxiliary gateway device 412. Instead, these communications devices 402 will be assigned the color identifier associated with primary gateway device 410 and will perform all communications exchanges to the fixed network through that primary gateway only.

Through periodic routing exchanges, communications devices 402 and 404 discover and establish association with a primary gateway device (e.g., primary gateway device 410) and become part of network segment 400. The communications devices (e.g., communications devices 402, 404) similarly discover the set of auxiliary gateway devices (e.g., auxiliary gateway devices 412 and/or 416) that are connectable via communications devices 402 and/or 404 of the primary gateway device's network segment. In one embodiment, based on the priority or service level designation of the communications accessed, a communications device 404 may select at least one of auxiliary gateway devices 412 and 416 with which to associate. That selection may be based on the optimal path to that particular auxiliary gateway device among the set of available auxiliary gateway devices that are within the auxiliary gateway horizon of connectivity for a particular communications device. The maximum horizon of connectivity for the auxiliary gateway devices may be defined to be different from the horizon specified for the primary segment gateway devices.

In an embodiment, auxiliary gateway device 412 with which a communications device 404 may associate for access to particular services of the communications server may be configured through direct communications initiated at the communications server. For certain anomalous failure events, service communications to auxiliary gateway 412 may also be permitted for all communications devices 402 without prior association signaling.

In one embodiment, one or more communications devices 402, which are not assigned to auxiliary gateway devices 412 or 416, are capable of being used as a relay or intermediary communications device. For instance, a communications device 404 may determine that its optimal path to auxiliary gateway device 412 involves one or more communications devices 402 (referred to, for example, as “hops”). As auxiliary gateway device 412 is accessible to one or more communications devices that are part of network segment 400, communications devices 404 as part of network segment 400 will therefore have routing information associated with communications devices 402 stored thereon necessary for identifying connectivity to auxiliary gateway device 412. For instance, communications devices 404 are structured to store, in memory, routing information associated with each communications device 404, each communications device 402, auxiliary gateway device 412, and primary gateway device 410, as well as one or more additional gateway devices (e.g., auxiliary gateway device 416) that is interconnected to network segment 400. Therefore, communications devices 404 and auxiliary gateway device 412 are interconnected through a portion of network segment 400 of the overall mesh network (e.g., network 100).

FIG. 5 is an illustrative schematic diagram of an exemplary routing table 500 for a communications device within a network, in accordance with an embodiment of the disclosed concept. Routing table 500 includes routing information for each communications device (e.g., communications devices 104a-c and the like) within a network (e.g., network 100). Routing table 500 is one illustrative form of the type of routing information that is capable of being stored within memory of each communications device. Furthermore, some or all of the routing information stored in routing table 500 is capable of being exchanged within one or more additional communications devices within a particular segment of a network.

Routing table 500 is structured, in a non-limiting illustrative embodiment, in the form of entries. Each entry includes, at least, a destination address element 502, a routing information element 504, a routing path description element 506, a color element 508, and a flag element 510. Various other types of information is also capable of being stored within routing table 500, including, but not limited to, device type information, physical location information, power level information, data communications information, and the like.

Destination address element 502, in one embodiment, corresponds to a unique address pertaining to a communications device of the destination. For example, destination address element 502 may correspond to a Media Access Control (“MAC”) address, an IP address, a serial number, or any other type of network address. Routing information element 504, in one embodiment, corresponds to an address of the communications device that is to be used as a next hop to reach an intended destination. For example, a particular communications device may have another communications device listed as a next hop to use in order to reach a communications, gateway, or auxiliary gateway device.

Routing path description element 506, in one embodiment, includes information that is capable of being used to determine an optimal path to use to reach a particular destination. For example, this information may correspond to a quality of the wireless link in the routing path to form a suitable metric, a number of hops to reach a destination, an efficiency score, and the like. The destination address element 502 of all devices, including the auxiliary gateway devices, within the segment are maintained in the routing table 500 allowing communications devices with specific communications requirements to select among the set of auxiliary gateways supporting the applicable level of service and offering the best (least-cost) routing path to a communications server.

Color element 508, in one embodiment, corresponds to a color identifier of a particular destination. For example, the color identifier may correspond to the color identifier of the destination communications device or gateway device that these devices have selected, or have had selected, for themselves. The color element 508 thus provides the central distinguishing element for communications devices within a common primary gateway segment routing domain. In addition to gateway and auxiliary gateways, information must be maintained within the routing table for all communications devices that have the same color element. Flag element 510, in one embodiment, includes various flags that describe the destination. For example, flag element 510 indicates whether the particular destination corresponds to a gateway device, an auxiliary gateway device, or a communications device, whether the destination is a stale entry marked for deletion, and/or whether the destination is flagged to not be used (e.g., during a power outage, system update, etc.). The flag element 510, in one embodiment, includes a specification of the service level capability of the associated auxiliary gateway device. This provides an indicator of the category or level of communications that is supported by the auxiliary gateway device and can influence the communications devices that choose to establish associations with the auxiliary gateway device. Multiple auxiliary gateway devices within the routing table may therefore have the same assigned service level indicator in the flag element. The service level indicator provides common service accessibility to communications devices that may be part of different primary segments independent of underlying automatic segmenting and merging of primary segment routing domains.

Each communications device is structured to employ various standardized routing protocols based on periodic communications exchanges amongst communications devices. Such routing protocols are described in greater detail within commonly assigned U.S. Pat. No. 7,035,207, which issued on Apr. 25, 2006, the disclosure of which is incorporated herein by reference in its entirety. These routing methods are applied to establish optimal bi-directional connection paths between devices. In a full mesh routing scheme, all communications devices within a given segment will maintain within their routing table 500 a destination address 502 for all of the other devices in the segment including the primary and auxiliary gateways. The routing table 500 may also include a destination address 502, corresponding to each of the primary and auxiliary gateway devices that may be reachable across interconnected segments.

In one embodiment, a tree-based or directed acyclic graph (“DAG”)-based routing protocol (for example, see IETF RFC 6550, RPL: IPv6 Routing Protocol for Low-Power and Lossy Networks) may be applied whereby each communications device is structured to maintain within its routing table 500, in addition to a destination address entry 502 for all interconnected primary and auxiliary gateways, a destination address entry 502 only for a subset of the communications devices within the segment. The subset of the segment destination addresses 502 will correspond only to the communications devices that connect to the serving primary gateway through the particular communications device. In this particular embodiment, a communications device will additionally only maintain within its routing table 500, the subset destination addresses 502 that correspond to communications devices that connect to one or more of the auxiliary gateways through the particular communications device. This tree- or DGA-based routing embodiment will allow even greater routing scalability by reducing the overall size and maintenance of the routing table 500 while preserving optimal bi-directional connection paths between each communications device and the primary gateway and between the auxiliary gateways and the respective associated communications devices.

Furthermore, each gateway device—primary and/or auxiliary—is capable of storing its own routing table as well. In one embodiment, a gateway device's routing table includes routing information indicating the other gateway devices within the network. For instance, a primary gateway device may store routing information associated with reaching another primary gateway device and/or an auxiliary gateway device.

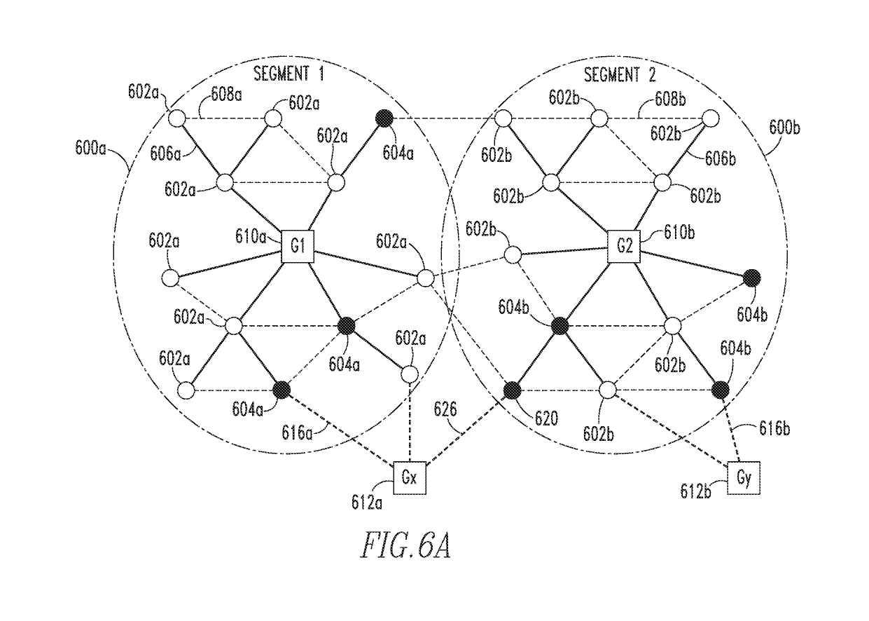

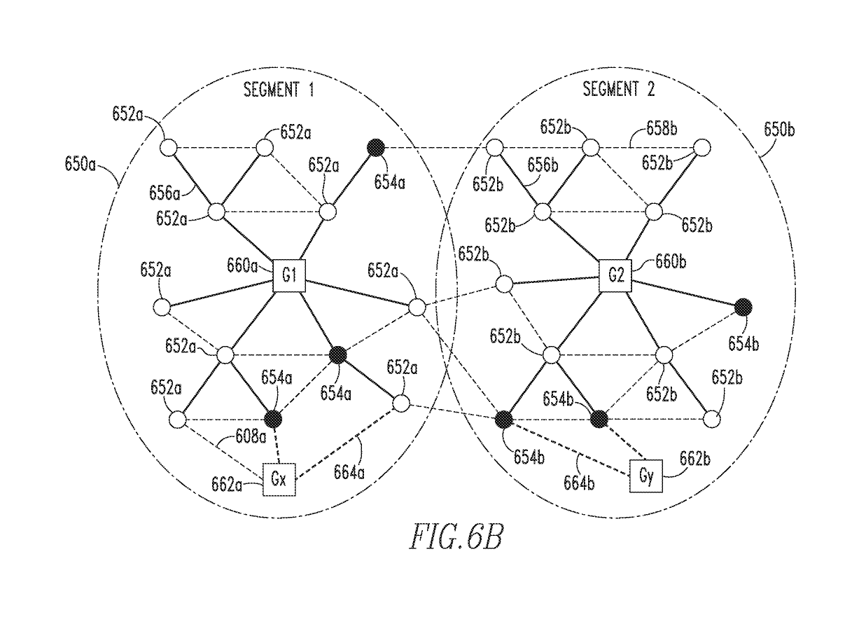

FIGS. 6A and 6B are illustrative diagrams of two network segments, each including a primary gateway device, and two auxiliary gateway devices deployed for one or more communications devices of the two network segments, in accordance with an embodiment of the disclosed concept. In the illustrative, non-limiting embodiment of FIG. 6A, a first network segment 600a and a second network segment 600b are described. First network segment 600a includes one or more communications devices 602a and 604a, and second network segment 600b includes one or more communications devices 602b and 604b. Communications devices 602a, 602b, in one embodiment, are substantially similar to communications devices 402 of FIG. 4, and communications devices 604a, 604b are substantially similar to communications devices 404 of FIG. 4, and the previously description may apply. For example, communications devices 604a and 604b may correspond to high data volume communications devices. These communications devices may absorb a large quantity of bandwidth for primary gateway devices 610a and 610b, respectively.

First network segment 600a includes a first primary gateway device 610a having has a first color identifier. Similarly, second network segment 600b includes a second primary gateway device 610b having a second color identifier. First primary gateway device 610a and second primary gateway device 610b are, in one embodiment, substantially similar to primary gateway device 410 of FIG. 4, and the previous description may apply. Solid lines 606a and 606b, in one embodiment, indicate an optimal path for a communications device to a particular primary gateway device, similarly to that of solid lines 406 of FIG. 4, and the previous description applies. Dashed lines 608a and 608b indicate an alternate route for a particular communications device of first network segment 600a and second network segment 600b, respectively, similar to that of dashed lines 408 of FIG. 4, and the previous description applies.

In one embodiment, when deployed within a network, communications devices 602a, 602b, 604a, and 604b assign themselves a color identifier associated with one of primary gateway device 610a or 610b. For instance, communications devices 602a and 604a assign themselves the first color identifier associated with first primary gateway device 610a, while communications devices 602b and 604b assign themselves the second color identifier associated with second primary gateway device 610b. Therefore, first primary gateway device 610a and communications devices 602a, 604a form first network segment 600a, in the illustrative embodiment, and second primary gateway device 610b and communications devices 602b, 604b form second network segment 600b. Generally speaking, network segments 600a and 600b are substantially similar to network segment 400 of FIG. 4.

In a non-limiting embodiment, a first auxiliary gateway device 612a and a second auxiliary gateway device 612b are also deployed within the network (e.g., a network made up of at least first network segment 600a and second network segment 600b). First auxiliary gateway device 612a and second auxiliary gateway device 612b are, in the illustrative embodiment, structured to facilitate communications of a particular data type, such as high data volume communications. Therefore, communications devices 604a and 604b, optimally, would be capable of communicating with auxiliary gateway devices 612a and 612b, respectively, to reach a final destination (e.g., a central or fixed communications server).

As seen from FIG. 6A, first auxiliary gateway device 612a is deployed in the vicinity of one or more communications devices from first and second network segments 600a and 600b. Accordingly, certain communications devices may be capable of using first auxiliary gateway device 612a instead of the primary gateway device associated with their network segment. As an illustrative example, communications devices 604a of first network segment 600a can use a third color identifier associated with first auxiliary gateway device 612a. Communications devices 604a, therefore, store entries within their routing table (e.g., routing table 500) indicating a next hop communications device that can be used to reach first auxiliary gateway device 612a. In one embodiment, the next hop is a communications device that accessed a fixed server using a different gateway device. For example, one communications device 604a may reach first auxiliary gateway device 612a via one or more communications devices 602a. As seen within FIG. 6A, darkened dashed lines 616a indicate a direct communications link between a particular communications device and first auxiliary gateway device 612a.

In one non-limiting embodiment, communications devices from two different network segments are capable of communicating the same auxiliary gateway device. For example, communications devices 604a—which are part of first network segment 600a—may be structured to communicate with first auxiliary gateway device 612a, and communications device 620—which is part of second network segment 604b—may be structured to also communicate with first auxiliary gateway device 612 via a direct communications link 626. Therefore, in this particular scenario, communications devices 604a and 620 both use the third color identifier associated with first auxiliary gateway device 612a, indicating that communications devices 604a and 620 are both capable of communicating with an auxiliary gateway that is independent of their corresponding network segments.

In one embodiment, second auxiliary gateway device 612b is deployed proximate to communications devices 604b for facilitating data communications of a particular data type, such as high data volume communications. Second auxiliary gateway device 612b, therefore, has a fourth color identifier associated therewith, and thus communications devices 604b are able to use the fourth color identifier for accessing the communications server via the second auxiliary gateway device 612b. Communications devices 604b are thus capable of communicating with the communications server via a network access that is independent of their corresponding network segment (e.g., network segment 600b). As seen within FIG. 6A, darkened dashed lines 616b indicate a direct communications link between a particular communications device and second auxiliary gateway device 612b.

In the illustrative, non-limiting embodiment of FIG. 6B, a first network segment 650a and a second network segment 650b are described. First network segment 650a includes one or more communications devices 652a and 654a, and second network segment 650b includes one or more communications devices 652b and 654b. Communications devices 652a, 652b, 654a, and 654b, in one embodiment, are substantially similar to communications devices 602a, 602b, 604a, and 604b of FIG. 6A, and the previously description may apply.

First network segment 650a includes a first primary gateway device 660a having has a first color identifier. Similarly, second network segment 650b includes a second primary gateway device 660b having a second color identifier. First primary gateway device 660a and second primary gateway device 660b are, in one embodiment, substantially similar to first and second primary gateway devices 610a and 610b, respectively, of FIG. 6A. Furthermore, solid lines 656a and 656b, in one embodiment, indicate an optimal path for a communications device to a particular primary gateway device, similarly to that of solid lines 606a and 606b of FIG. 6A, and the previous description applies. Dashed lines 658a and 658b indicate an alternate route for a particular communications device of first network segment 650a and second network segment 650b, respectively, similar to that of dashed lines 608a and 608b, respectively, of FIG. 6A, an d the previous description applies.

First network segment 650a, in one embodiment, includes a first auxiliary gateway device 662a, and second network segment 650b includes a second auxiliary gateway device 652b are also deployed within the network (e.g., a network made up of at least first network segment 650a and second network segment 650b). First auxiliary gateway device 652a and second auxiliary gateway device 652b are, in the illustrative embodiment, structured to facilitate communications of a particular data type, such as high data volume communications. Therefore, communications devices 654a and 654b, in a particular embodiment, would be capable of communicating with auxiliary gateway devices 652a and 652b, respectively, to reach a final destination (e.g., a central or fixed communications server).

As seen from FIG. 6B, first auxiliary gateway device 662a is deployed as part of the first network segment 650a. This may specifically be achieved through direct configuration of the auxiliary gateway device's color or through dynamic assignment based on signaling between auxiliary gateway device 662a and primary gateway device 660a of first network segment 650a, which are determined through network routing to be the closest (shortest routing path) primary gateway device relative to other network primary gateway devices. Similarly, second auxiliary gateway device 662b is, in the illustrative embodiment, deployed as part of second network segment 660b. This may also be based on direct configuration of the auxiliary gateway device's color or through dynamic assignment based on closest proximity to primary gateway device 660b of second network segment 650b relative to other network primary gateway devices. By virtue of the auxiliary gateway devices being associated with, and having the color of a particular primary gateway device, optimal bidirectional connectivity to and from those auxiliary gateway devices is able to be maintained for all communications devices within a particular network segment through the normally defined network routing exchanges. Accordingly, certain communications devices may be capable of using first auxiliary gateway device 662a instead of primary gateway device 660a associated with their network segment (e.g., network segment 600a) for accessing a fixed communications server. As an illustrative example, communications devices 654a of first network segment 650a may use the primary segment color identifier for communications with first auxiliary gateway device 662a. Communications devices 654a, therefore, are capable of storing entries within their routing table (e.g., routing table 500) indicating a next hop communications device that can be used to reach first auxiliary gateway device 662a. In one embodiment, the next hop communications device is a communications device that accesses a fixed server using a primary gateway device. For example, one communications device 664a may reach first auxiliary gateway device 662a via one or more communications devices 652a. As seen within FIG. 6B, darkened dashed lines 664a indicate a direct communications link between a particular communications device and first auxiliary gateway device 662a.

In one embodiment, second auxiliary gateway device 662b is deployed proximate to communications devices 664b for facilitating data communications of a particular data type, such as high data volume communications. Second auxiliary gateway device 662b has the second color identifier associated with primary network segment 650b, for instance. Communications devices 654b are thus capable of communicating with the (fixed) communications server via a network access that is part of their corresponding network segment (e.g., network segment 650b) but different from their network segment's corresponding primary gateway device (e.g., primary gateway device 660b). As seen within FIG. 6B, darkened dashed lines 664b indicate a direct communications link between a particular communications device (e.g., communications device 654b) and second auxiliary gateway device 662b.

FIG. 7 is an illustrative block diagram of an exemplary communications device 700, in accordance with an embodiment of the disclosed concept. Communications device 700, in one non-limiting embodiment, corresponds to any electronic device or system capable of communicating over a network with one or more additional devices. Various types of electronic devices include, but are not limited to, meters, sensors, actuators, media players cellular telephone, pocket-sized personal computer, personal digital assistant (“PDAs”), desktop computer, laptop computer, wearable electronic device, and/or tablet computer.

Communications device 700, in one embodiment, includes one or more processors 702, memory 704, communications circuitry 706, input/output (“I/O”) interface 708, and one or more meters 710. I/O interface 708, in one embodiment, includes one or more cameras, microphones, displays, and/or speakers. However, one or more of the previously mentioned components may be combined or omitted, and/or one or more components may be added. For example, communications device 700 may additionally include a power supply, a bus connector, a radio receiver, a data source, a clock, or any other additional component. In one embodiment, communications device 700 includes multiple instances of one or more of the aforementioned components, however, for the sake of simplicity, only one of each component has been shown within FIG. 7.

Processor(s) 702 correspond, in the illustrative embodiment, to any suitable processing circuitry capable of controlling operations and functionality of communications device 700, as well as facilitating communications between communications device 700, and any other communications devices and/or gateway devices. In one embodiment, processor(s) 702 include a central processing unit (“CPU”), a graphic processing unit (“GPU”), one or more microprocessors, a digital signal processor, and/or any other type of processor, or any combination thereof. The functionality of processor(s) 702 is capable of being performed by one or more hardware logic components including, but not limited to, field-programmable gate arrays (“FPGA”), application specific integrated circuits (“ASICs”), application-specific standard products (“ASSPs”), system-on-chip systems (“SOC s”), and/or complex programmable logic devices (“CPLDs”). Furthermore, processor(s) 702, in one embodiment, is structured to include its own local memory, such that one or more program modules, program data, and/or one or more operating systems are capable of being stored thereby. Processor(s) 702 are also capable of running an operating system (“OS”) communications device 700, and/or one or more firmware applications, media applications, and/or applications resident thereon.

Memory 704, in the illustrative embodiment, corresponds to one or more types of storage mediums such as any volatile and/or non-volatile memory, and/or any removable and/or non-removable memory, which is capable of being implemented in any suitable manner to store data on communications device 700. For example, information may be stored using computer-readable instructions, data structures, and/or program modules. Various types of storage/memory include, but are not limited to, hard drives, solid state drives, flash memory, permanent memory (e.g., ROM), electronically erasable programmable read-only memory (“EEPROM”), CD ROM, digital versatile disk (“DVD”) or other optical storage medium, magnetic cassettes, magnetic tape, magnetic disk storage or other magnetic storage devices, RAID storage systems, or any other storage type, or any combination thereof. Furthermore, memory 704 is, in one embodiment, capable of being implemented as computer-readable storage media (“CRSM”) corresponding to any available physical media accessible by processor(s) 702 to execute one or more instructions stored by memory 704.

Communications circuitry 706, in a non-limiting embodiment, includes any circuitry capable of connecting to a communications network (e.g., network 100) and/or transmitting communications (voice or data) to one or more devices (e.g., communications devices 104a-c) and/or gateway devices (e.g., gateway devices 110a-c). Communications circuitry 706 is further capable of interfacing with a communications network using any suitable communications protocol including, but not limited to, Wi-Fi (e.g., 802.11 protocol), Bluetooth®, radio frequency systems (e.g., 900 MHz, 1.4 GHz, and 5.6 GHz communications systems), infrared, GSM, GSM plus EDGE, CDMA, quadband, VOIP, or any other protocol, or any combination thereof.

I/O interface 708 corresponds any suitable mechanism or component for receiving inputs and/or generating outputs for communications device 700. The input portion of I/O interface 708 corresponds to any suitable input component, including, but not limited to, an external keyboard, mouse, joystick, or any other suitable input mechanism, or any combination thereof.

The input portion of I/O interface 708, in one embodiment, further includes one or more image capturing components capable of capturing images and/or videos. For example, communications device 700 may include one or more cameras capable of capturing photographs, sequences of photographs, rapid shots, videos, or any other type of image, or any combination thereof. In one embodiment, a portion, or a feature of the input portion of I/O interface 708 is external to communications device 700, however this is merely exemplary.

Communications device 700, in one embodiment, also includes one or more microphones capable of detecting audio signals. For example, such microphones may include one more sensors or transducers for generating electrical signals and circuitry capable of processing the generated electrical signals. Multiple microphones capable of detecting various frequency levels (e.g., high-frequency microphone, low-frequency microphone, etc.) are also capable of being included for communications device 700, however one or external microphones are capable of being connected to communications device 700.

Communications device 700 is capable of communicating with one or more additional communications devices and/or gateway devices using any network, combination of networks, or network devices that configured carry data communications.

For example, one or more local area networks (“LAN”), wide area networks (“WAN”), telephone networks, wireless networks, point-to-point networks, star networks, token ring networks, hub networks, ad-hoc multi-hop networks, or any other type of network, or any combination thereof, are capable of being used. Furthermore, communications circuitry 706 is structured to support any number of protocols such as WiFi (e.g., 802.11 protocol), Bluetooth®, radio frequency systems (e.g., 900 MHZ, 1.4 GHZ, and 5.6 GHZ communication systems), cellular networks (e.g., GSM, AMPS, GPRS, CDMA, EV-DO, EDGE, 3GSM, DECT, IS-136/TDMA, iDen, LTE, or any other suitable cellular network protocol), infrared, TCP/IP (e.g., any of the protocols used in each of the TCP/IP layers), HTTP, BitTorrent, FTP, RTP, RTSP, SSH, Voice over IP (“VOIP”), or any other communication protocol, or any combination thereof.

The output portion of I/O interface 708, in one embodiment, includes any suitable mechanism or component for operating communications device 700. In a non-limiting embodiment, the output portion of I/O interface 708 includes one or more displays. Any type of display capable of presenting content is capable of being employed by communications device 700, and the display may be of any size and may be located at any suitable position about communications device 700. Various display types include, but are not limited to, liquid crystal displays (“LCD”), monochrome displays, color graphics adapter (“CGA”) displays, enhanced graphics adapter (“EGA”) displays, variable graphics array (“VGA”) displays, or any other display type, or any combination thereof. Furthermore, the display, in one embodiment, is a touch screen and/or an interactive display. The display, in one embodiment, is structured to include a multi-touch panel coupled to processor(s) 702, and/or structured to be a touch screen including capacitive sensing panels.

The output portion of I/O interface 708 also, in a non-limiting embodiment, includes one or more speakers outputting audio signals. For example, one or more speaker units, transducers, or array of speakers and/or transducers capable of broadcasting audio signals and audio content may be included by communications device 700. A visible light communications I/O device interface may also be supported.

Communications device 700, in the illustrative embodiment, further includes one or more meters 710. Such meters include, but are not limited to, seismic monitoring meters, precision agriculture meters, environmental and/or atmospheric monitoring meters, automated electricity meters, gas meters, water meters, industrial control meters, and the like. Meter(s) 710, for example, may correspond to one or more sensors, actuators, and/or radio devices, that are structured to measure a particular quantity (e.g., voltage, current, weight, etc.), and cause that measurement to be stored within memory 704, and/or sent to one or more additional devices using communications circuitry 706.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A communications system, comprising:
a first primary gateway device for facilitating communications of a first data type, the first primary gateway device having a first color identifier associated with a first network segment of a multi-hop mesh network, and the first primary gateway device having a first fixed connection to a communications server;
at least one first communications device capable of communicating communications of the first data type with the communications server via the first primary gateway device, the at least one first communications device having the first color identifier indicating that the at least one first communications device is part of the first network segment;
a first auxiliary gateway device for facilitating communications of a second data type, the first auxiliary gateway device having a second color identifier, the second color identifier indicating that the first auxiliary gateway device is independent of the first network segment, and the first auxiliary gateway device having a second fixed connection to the communications server; and
at least one second communications device capable of communicating with the communications server via the first auxiliary gateway device, the at least one second communications device including:
the first color identifier indicating that the at least one second communications device is part of the first network segment; and
capable of using the second color identifier indicating that the at least one second communications device communicates data of the second data type with the first auxiliary gateway device.

2. The communications system of claim 1, wherein:
the at least one first communications device stores at least:
first primary gateway routing information indicating a first optimal path to the first primary gateway device for the at least one first communications device; and
first auxiliary gateway routing information indicating a second optimal path to the first auxiliary gateway device for the at least one first communications device; and
the at least one second communications device stores at least:
second auxiliary gateway routing information indicating a third optimal path to the first auxiliary gateway device for the at least one second communications device; and
second primary gateway routing information indicating a fourth optimal path to the first primary gateway device for the at least one second communications device.

3. The communications system of claim 1, wherein the at least one second communications device is capable of communicating with the first auxiliary gateway device using a first communications device of the at least one first communications device.

4. The communications system of claim 1, further comprising:
a second primary gateway device for facilitating communications of the first data type, the second primary gateway device having a third color identifier associated with a second network segment of the multi-hop mesh network, and the second primary gateway device having a third fixed connection to the communications server; and
at least one third communications device capable of communicating communications of the first data type with the communications server via the second primary gateway device, the at least one third communications device including the third color identifier indicating that the at least one third communications device is part of the second segment.

5. The communications system of claim 1, further comprising:
a second auxiliary gateway device for facilitating communications of the second data type, the second auxiliary gateway device having a third color identifier, the third color identifier indicating that the second auxiliary gateway device is independent of at least the first network segment, and the second auxiliary gateway device having a third fixed connection to the communications server; and
at least one third communications device capable of communicating with the communications server via the second auxiliary gateway device, the at least one third communications device capable of using at least the third color identifier.

6. A system, comprising:
a first network access device capable of communicating with a server, the first network access device having a first identifier corresponding to a first segment of a network;
a first plurality of communications devices in communication with the first network access device and having the first identifier;
a second network access device capable of communicating with the server via the second network access device, the second network access device having a second identifier; and
a second plurality of communications devices having the first identifier and using the second identifier for communicating with the server via the second network access device.

7. The system of claim 6, wherein the second plurality correspond to high data volume communications devices.

8. The system of claim 6, wherein at least one of the second plurality is structured to communicate with the second network access device via at least one of the first plurality.

9. The system of claim 6, wherein the communications devices of the first plurality and the second plurality comprise:
memory structured to store:
first routing information indicating a first next communications device within the network for accessing the server via the first network device;
second routing information indicating a second next communications device within the network for accessing the server via the second network access device; and
the first identifier.

10. The system of claim 6, further comprising:
a third network access device capable of communicating with the server, the third network access device having a third identifier that indicates that the third network access device is independent of the first segment.

11. The system of claim 10, further comprising:
at least one third communications devices in communication with the third network access device and having the third identifier, the third plurality being capable of communicating with the server using the third network access device.

12. The system of claim 6, further comprising:
a third network access device capable of communicating with the server, the third network access device having a third identifier corresponding to a second segment of the network; and
a third plurality of communications devices in communication with the third network access device and having the third identifier.

13. The system of claim 6, further comprising:
at least one communications device having a third identifier associated with a second segment of the network, wherein the at least one communications device is structured to communicate with the server via the second network access device.

14. A system, comprising:
a first primary network access device having a first identifier;
a first plurality of communications devices having the first identifier and forming a first network segment; and
a first auxiliary network access device having a second identifier, wherein:
at least one communications device of the first plurality of communications devices is structured to communicate with the first auxiliary network access device, the at least one communication device using the second identifier indicating that the first auxiliary network device is independent of at least the first primary network device.

15. The system of claim 14, further comprising:
a second primary network access device having a third identifier; and
a second plurality of communications devices having the third identifier and forming a second network segment, the first network segment differing from the second network segment.

16. The system of claim 15, further comprising:
at least one additional communications device of the second plurality structured to communicate with the first auxiliary network access device, the at least one additional communications device having the second identifier.

17. The system of claim 14, wherein the at least one communications device of the first plurality is structured to communicate with the first auxiliary network device via at least one additional communications device of the first plurality.

18. The system of claim 17, wherein the at least one additional communications device has the first identifier.

19. The system of claim 14, further comprising:
a second auxiliary network access device having a third identifier, wherein:
at least one additional communications device of the first plurality of communications devices is structured to communicate with the second auxiliary network access device, the at least one additional communications device using the third identifier indicating that the second auxiliary network device is independent of at least the first primary network device.

20. The system of claim 19, further comprising:
a second primary network access device having a fourth identifier; and
a second plurality of communications devices having the fourth identifier and forming a second network segment, wherein at least one other additional communications device of the second plurality is structured to communicate with the second auxiliary network access device, the at least one other additional communications device further using the third identifier.
